(19) United States
(12) Patent Application Publication
(10) Pub. No.: US 2009/0263773 A1
(43) Pub. Date: Oct. 22, 2009

(54) BREATHING EXERCISE APPARATUS AND METHOD

(76) Inventors: Vadim Kotlyar, Gilroy, CA (US); Anatoly Kotlyar, Gilroy, CA (US)

Correspondence Address: Haynes and Boone, LLP;IP Section, 2323 Victory Avenue, SUITE 700, Dallas, TX, 75219, US

(21) Appl. No.: 12/420,764

(22) Filed: Apr. 8, 2009

Related U.S. Application Data
(60) Provisional application No. 61/124,724, filed on Apr. 19, 2008.

(51) Int. Cl. G09B 23/28; G06F 3/048; G06F 3/01

(52) U.S. Cl. 434/262; 715/764; 715/716

(57) ABSTRACT

A breathing exercise apparatus includes (a) a graphical display, (b) input elements for receiving from a user durations for inhalation, exhalation and pause phases of a breathing exercise pattern; and (c) a controller for causing the graphical display to display a sequence of graphical images according to the received durations for the inhalation, the exhalation and the pause phases of the breathing exercise pattern. The breathing exercise apparatus may be implemented on a personal computer by providing on a computer-readable medium instructions executable by the computer that carry out the method which includes (a) receiving from a user durations for inhalation, exhalation and pause phases of a breathing exercise pattern; and (b) displaying on a graphical display a sequence of graphical images according to the received durations for the inhalation, the exhalation and the pause phases of the breathing exercise pattern. In one embodiment, the inhalation phase, the exhalation phase and the pause phase may each be specified more than once and may be arranged in any order the user desired, thereby providing the building blocks for constructing any and practically all possible breathing exercises.

### CROSS REFERNECE TO RELATED APPLICATIONS

The present invention is related to and claims priority of U.S. Provisional Patent Application, Ser. No. 61/124,724, entitled “Software program ‘Breath Management’ that allows users to create their own breathing exercise pattern based on existing breathing exercise methods or individual needs,” filed on Apr. 19, 2008.

### BACKGROUND OF THE INVENTION

1. Field of the Invention

The present invention relates to a device suitable for use with a breathing exercise or meditation. In particular, the present invention relates to a device that assists a person in a breathing exercise or mediation by setting timings for inhale, exhale and pauses in between inhale and exhale.

2. Discussion of the Related Art

An important element in all physical exercises is the regulation of breathing. In swimming, for example, a swimmer goes through regular cycles of inhalation, pause and exhalation. In fact, significant health benefits can be derived from a “breathing exercise.” In a breathing exercise, a person goes through a breathing pattern or sequence (e.g., inhalation—exhalation—pause) with timing control. The breathing exercise can be carried out in conjunction with a physical activity (e.g., swimming, or on an exercise bicycle), or without a physical activity. The breathing exercise is also often carried out by a person who practices meditation.

Existing breathing exercise programs (e.g., HeartTracker 3.0 Stress Reduction Software, Smooth deep breathing assistant, BP Ease v101, and Breathe-1:4:2 Version 1.2) are complicated and do not have flexibility for a user to program the breathing exercise pattern and durations based on the user's needs.

### SUMMARY

According to one embodiment of the present invention, a breathing exercise apparatus is provided which includes (a) a graphical display; (b) input elements for receiving from a user durations for inhalation, exhalation and pause phases of a breathing exercise pattern; and (c) a controller for causing the graphical display to display a sequence of graphical images representing and according to the received durations for the inhalation, the exhalation and the pause phases of the breathing exercise pattern. In one embodiment, the sequence of graphical images comprises a sequence of images in which an object is seen to increase in size during the inhalation phase, decrease in size during the exhalation phase and remain in a fixed size during the pause phase.

According to one embodiment of the present invention, one or more audio speakers are provided to play background music during a breathing exercise. The user may be allowed to select from pre-loaded recordings for the background music.

According to one embodiment of the present invention, an input element receives from a user a number of times to repeat the breathing exercise pattern. The controller repeats the breathing exercise pattern the specified number of times during the breathing exercise.

In one embodiment, the breathing exercise apparatus may be implemented by a personal computer. In one implementation, a program in software carries out a method which includes (a) receiving from a user durations for inhalation, exhalation and pause phases of a breathing exercise pattern; and (b) displaying on a graphical display a sequence of graphical images according to the received durations for the inhalation, the exhalation and the pause phases of the breathing exercise pattern.

In one embodiment, the inhalation phase, the exhalation phase and the pause phase may each be specified more than once and may be arranged in any order the user desired, thereby providing the building blocks for constructing any and practically all possible breathing exercises.

The present invention is better understood upon consideration of the detailed description below in conjunction with the drawings.

### BRIEF DESCRIPTION OF THE DRAWINGS

FIG. 1 shows device 100 for use in a breathing exercise, in accordance with one embodiment of the present invention.

FIG. 2 is a functional block diagram of device 100, according to one embodiment of the present invention.

FIG. 3 shows one visual representation of an inhalation phase, according to one embodiment of the present invention.

FIG. 4 shows one visual representation of an exhalation phase, according to one embodiment of the present invention.

### DETAILED DESCRIPTION OF THE PREFERRED EMBODIMENTS

The present invention provides a person carrying out a breathing exercise visual or audio cues to allow the person to maintain timing control for the different phases of a breathing exercise. The present invention can be embodied in a physical device or in software as an application program running in a computer. In the following detailed description, although the present invention is illustrated using a simple breathing exercise that consists merely of a simple 3-phase sequence of inhalation, exhalation and pause, with each phase having a user specified fixed duration, the present invention can be carried out for any breathing exercising of any complexity. For example, the breathing exercise may consist of repeated double-cycles of the 3-phase sequence, with each component cycle in the double-cycle having a different duration.

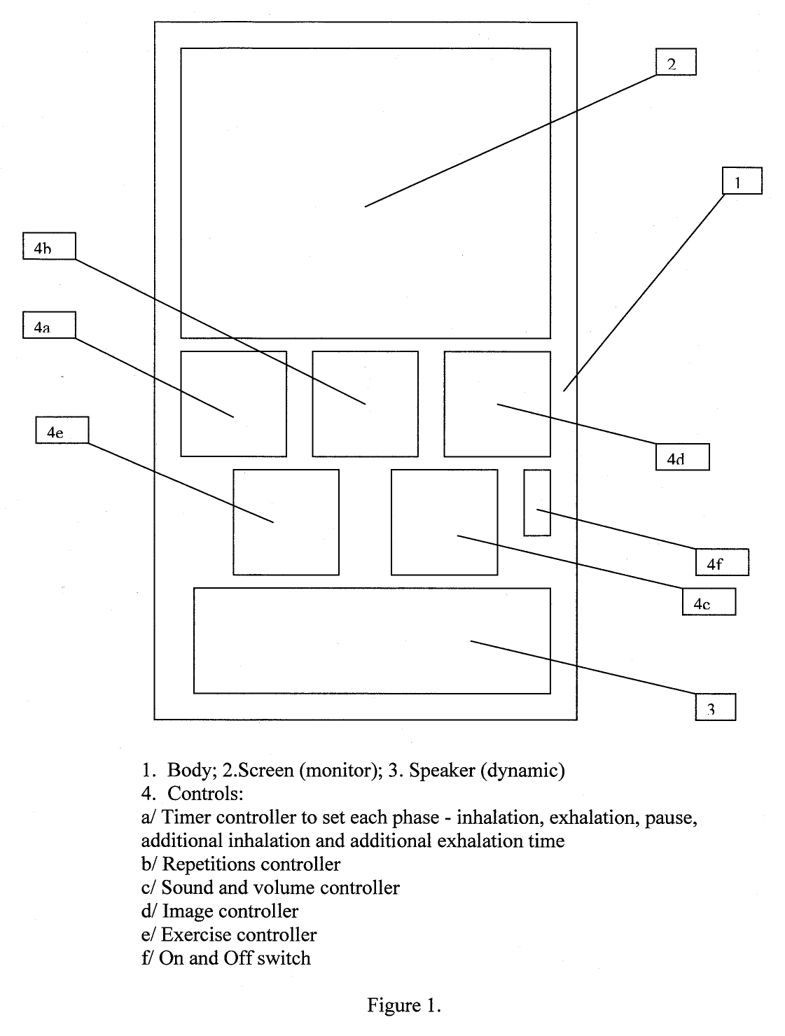

FIG. 1 shows device 100 for use in a breathing exercise, in accordance with one embodiment of the present invention. The breathing exercise can be used for an example by a swimmer training his or her breathing techniques outside of the pool. Device 100 can be programmed to direct the breathing cycles in the breathing exercise. In this regard, device 100 generates visual and audio representations of the programmed breathing exercise pattern to direct the actions of the person carrying out the breathing exercise. As shown in FIG. 1, device 100 includes housing 1, graphical display 2, speakers 3, and control knobs 4 which control (a) duration of each primary inhalation, exhalation, pause phases and additional inhalation, exhalation and pause phases in each sequence, (b) number of repetition of the sequence, (c) the sound to be used as audio and volume controller; (d) image controller for selection of a pre-programmed images to represent inhalation, exhalation and pause, (e) exercise controller which starts and stops the breathing exercise, and (f) the power (i.e., on-off) switch.

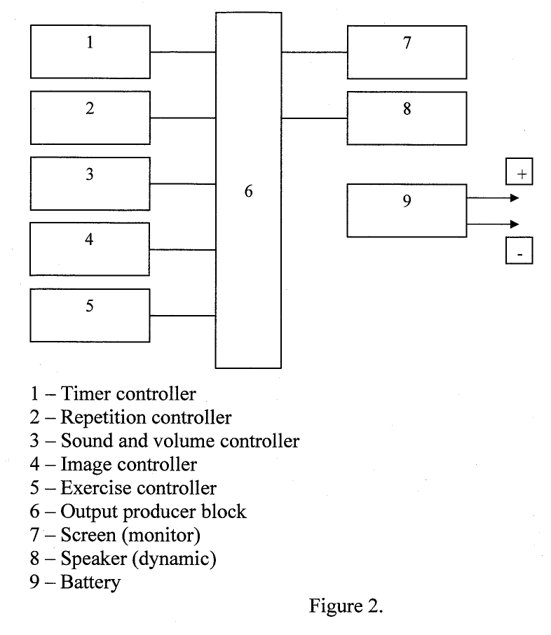

FIG. 2 is a functional block diagram of device 100, according to one embodiment of the present invention. As shown in FIG. 2, device 100 includes timer controller 1 which controls the durations of each phase of the breathing exercise. For example, timer controller monitors and sets the timing durations for the breathing exercise pattern or sequence: Inhalation—5 sec., exhalation—5 sec., pause 5 sec., additional inhalation—0 sec., and additional exhalation—0 sec. Device 100 also includes (a) repetition controller 2, which sets the number of repetitions (i.e., the number of cycles to repeat the programmed breathing exercise sequence); (b) sound and volume controller 3 which plays the selected sound track (e.g., music) for each phase of the breathing exercise at the selected speaker volume; (c) image controller 4 which displays the desired images that visually represent the respective phases of the breathing exercise pattern, (d) exercise controller 5 which controls storing, selecting, starting, pausing, canceling or deleting breathing exercises. The output signals of blocks 1-5 are provided output processing block 6 which drives display module 7 and audio processing module 8 to a graphical display and an audio signal processing unit (e.g., graphical display 2 and speakers 3 of FIG. 1), repsectively. Battery 9 supplies the power to operate device 100.

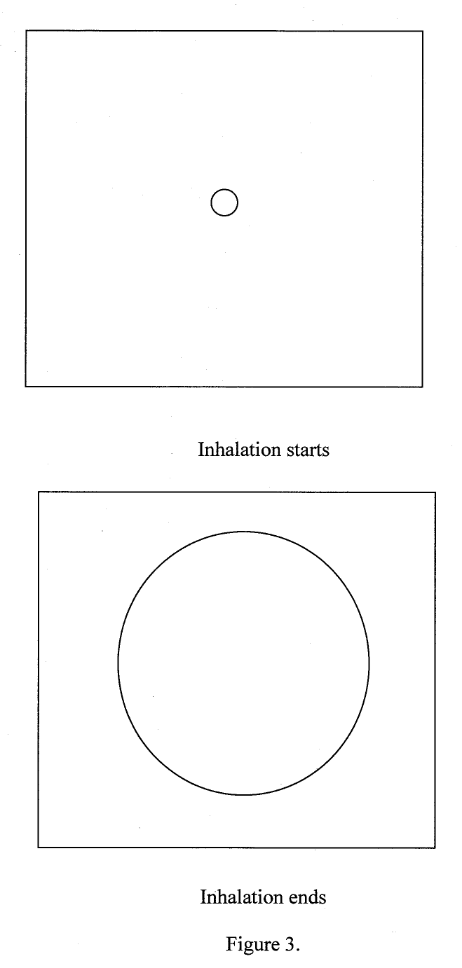

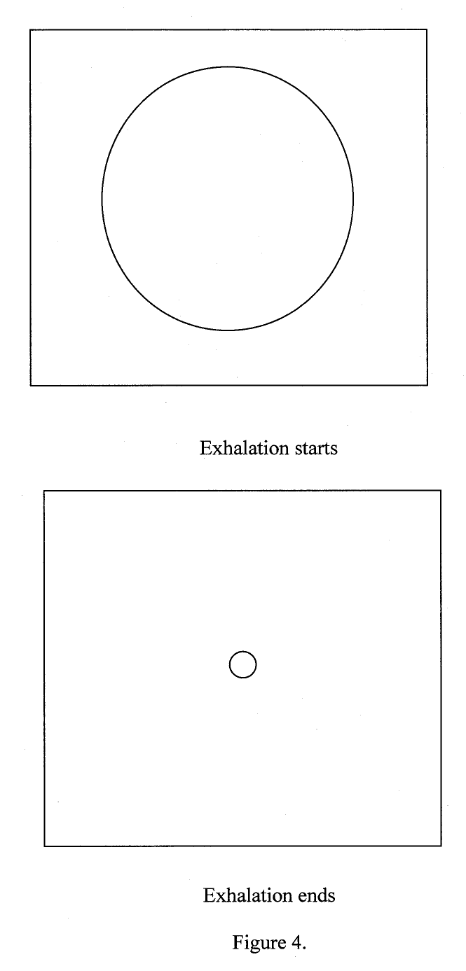

Device 100 may be programmed to conduct numerous possible breathing exercise patterns. A typical breathing exercise may include, for example, non-zero durations of inhalation, exhalation, pause, additional inhalation, and additional exhalation. During playback of a selected breathing exercise, device 100 provides visual and sound cues to indicate each phase of the breathing exercise. In one implementation, different phases are indicated by different sounds. FIG. 3 shows one visual representation of an inhalation phase, according to one embodiment of the present invention. As shown in the top half of FIG. 3, when inhalation starts, a small circle is displayed which gradually increases in size over the specified inhalation duration to become the large circle shown in the bottom half of FIG. 3. Likewise, during an exhalation phase, the large circle reached in the previous inhalation phase (i.e., bottom half of FIG. 3) is gradually reduced in size over the specified exhalation duration to return to small circle shown in the top half of FIG. 3. This exhalation phase is illustrated by FIG. 4. During the pause phase, the small circle size is maintained for the specified duration.

Device 100 may also be implemented on as a “breath management” software program designed to run on a personal computer. Such personal computer may include, for example, a laptop computer, a digital personal assistant (PDA), or a cellular telephone (e.g., an iPhone). A breath management program allows a user to create a breathing exercise sequence for use in a breathing exercise, according to the user's individual needs. This program provides on the personal computer visual and audio output to aid or guide the user during the programmed breathing exercise. The present invention provides a user the ability to program any suitable exercise pattern or sequence to cover any possible breathing exercise methods.

In one embodiment, the program allows a user to specify a breathing exercise pattern by specifying an inhalation time, a pause time, an exhalation time and a number of times to repeat the exercise pattern. In this program, inhalation, exhalation and pause are components that allow a user to build practically all breathing exercise patterns that are used in existing breathing exercises. In one embodiment, after initialization, the program displays an exercise panel showing “action” and “time” options, as well as “add option” and “delete option” buttons, If the user clicks on the “action” option, a drop-down menu is displayed providing “inhalation,” “pause,” and “exhalation” option selections. When the user selects the “inhalation” option, the user can enter or select a desired time (e.g., 10 seconds) for an inhalation phase. After specifying the inhalation duration, for example, the user may select “action” again to define the next phase. The drop-down menu appears again to allow the user to select an “inhalation,” “pause,” or “exhalation” option to specify the next phase and its duration. For example, if the user selects the “pause” option, the user may enter or select a desired time for a pause (e.g., 2 seconds). Similarly, the user may also select “action” again to allow selecting the “exhalation” option, so as to enter or select a desired duration for exhalation (e.g., 10 seconds). A “pause” duration may be specified by selecting “action” and “pause” options to enter or select a desired time for a second pause duration to follow the “exhalation” phase. Any of the specified actions may be removed by selecting a “delete action” button.

The user may select the “time” option to specify a repetition count, which is entered by typing or selecting the desired times (e.g., 5 times). Note that the total exercise time is adjusted when a user add another action, changes the duration of an action, or the number of times to repeat the exercise pattern.

In one embodiment, when a user selects the “add option” button, a drop-down menu provides a list of experience-enhancing options, such ass a “background music” option to allow a user to add background music to be played during the breathing exercise. In one embodiment, the background music option also provides a list of background music files from which the user may select the background music.

After completing specification of the actions and options for a breathing exercise, the user may save the breathing exercise into a specified file. In one embodiment, a “start exercise” button is provided, which allows a user to begin the current breathing exercise that has been defined in the current session, or to activate a saved breathing exercise. The program is terminated by selecting an “exit” button.

In one embodiment, the program repeats the breathing exercise pattern by displaying on the graphical display the patterns of FIGS. 3 and 4. In one embodiment, the program tracks and displays exercise time, remaining time of current step, the remaining actions with their respective remaining action durations, the remaining number of times of repetition of the exercise pattern and the selected animated image that helps the user's concentration.

The above detailed description is provided to illustrate the specific embodiments of the present invention and is not intended to be limiting. Numerous modifications and variations within the scope of the present invention are possible. The present invention is set forth in the following claims.

We claim:

1. A breathing exercise apparatus, comprising:
a graphical display;
input elements for receiving from a user durations for inhalation, exhalation and pause phases of a breathing exercise pattern; and
a controller for causing the graphical display to display a sequence of graphical images according to the received durations for the inhalation, the exhalation and the pause phases of the breathing exercise pattern.

2. A breathing exercise apparatus as in claim 1, wherein the sequence of graphical images comprise a sequence of images in which an object is seen to increase in size during the inhalation phase.

3. A breathing exercise apparatus as in claim 1, wherein the sequence of graphical images comprise a sequence of images in which an object is seen to decrease in size during the exhalation phase.

4. A breathing exercise apparatus as in claim 1, wherein the sequence of graphical images comprise a sequence of images in which an object is seen to remain in a fixed size during the pause phase.

5. A breathing exercise apparatus as in claim 1, further comprises one or more audio speakers for playing background music during a breathing exercise.

6. A breathing exercise apparatus as in claim 5, wherein a plurality of recordings are provided to allow user selection of background music.

7. A breathing exercise apparatus as in claim 1, further comprising an input element for receiving a number of times to repeat the breathing exercise pattern, and wherein the controller repeats the breathing exercise pattern the number of times to repeat.

8. A breathing exercise apparatus as in claim 1, wherein the inhalation phase, the exhalation phase and the pause phase are independently specified.

9. A breathing exercise apparatus as in claim 8, wherein the breathing exercise pattern comprises one or more inhalation phases, one or more the exhalation phases and one or more pause phases.

10. A breathing exercise apparatus as in claim 9, wherein the input elements provide user specification of an order for the inhalation, exhalation and pause phases.

11. A computer-readable medium comprising instructions executable by a computer for carrying out a method comprising:
receiving from a user durations for inhalation, exhalation and pause phases of a breathing exercise pattern; and
displaying on a graphical display a sequence of graphical images according to the received durations for the inhalation, the exhalation and the pause phases of the breathing exercise pattern.

12. A computer-readable medium as in claim 10, wherein the sequence of graphical images comprise a sequence of images in which an object is seen to increase in size during the inhalation phase.

13. A computer-readable medium as in claim 10, wherein the sequence of graphical images comprise a sequence of images in which an object is seen to decrease in size during the exhalation phase.

14. A computer-readable medium as in claim 10, wherein the sequence of graphical images comprise a sequence of images in which an object is seen to remain in a fixed size during the pause phase.

15. A computer-readable medium as in claim 10, the method further comprising playing through one or more audio speakers background music during a breathing exercise.

16. A computer-readable medium as in claim 15, the method further comprising providing a plurality of recordings to allow user selection of background music.

17. A computer-readable medium as in claim 13, the method further comprising providing an input element to receive a number of times to repeat the breathing exercise pattern, and repeating the breathing exercise pattern the number of times to repeat.

18. A computer-readable medium as in claim 10, wherein the inhalation phase, the exhalation phase and the pause phase are independently specified.

19. A computer-readable medium as in claim 10, wherein the breathing exercise pattern comprises one or more inhalation phases, one or more the exhalation phases and one or more pause phases.

20. A computer-readable medium as in claim 19, wherein the input elements provide user specification of an order for the inhalation, exhalation and pause phases.
